(19) United States
(12) Patent Application Publication
(10) Pub. No.: US 2026/0284701 A1
(43) Pub. Date: Sep. 24, 2026

(54) Method for managing coating gloss on a coil-coating line

(71) Applicant: ArcelorMittal, Luxembourg (LU)

(72) Inventors: Fabrice FARINA, Flémalle (BE); Jacky MALLEGOL, Villers Le Temple (BE); Charles HANQUET, Liege (BE); Thomas DEFIZE, Eben-Emael (BE); Maria ALBARRACIN, Bétera (Valencia) (ES); Vincent RUWET, Housse (BE)

(21) Appl. No.: 19/470,033

(22) PCT Filed: Mar. 27, 2024
(86) PCT No.: PCT/IB2024/052940

§ 371 Date: Sep. 27, 2025

(30) Foreign Application Priority Data
Apr. 6, 2023 (WO) PCT/IB2023/053521

(51) Int. Cl. B05D 3/06; B05D 5/06; B05D 7/14

(52) U.S. Cl. CPC B05D 3/067; B05D 3/068; B05D 5/061; B05D 7/14; B05D 2202/25; B05D 2252/02; B05D 2401/30

(57) ABSTRACT

A method for managing the gloss of an organic coating formed on a moving strip on a coil-coating line including sequentially a paint applicator, a cooling device including a cooling module, an Ultra-Violet curing device and an Electron-Beam curing device, the method including correcting a deviation of the measured gloss G beyond a set gloss range Rₛ, the correction including calculating the corrected temperature T_{c} to be reached by the wet film, in the at least a width portion downstream of the cooling module and upstream of the Ultra-Violet curing device, according to equation T_{c}=T+K (G−Gₛ) and adjusting a setting of the coil-coating line taking into account the calculated corrected temperature T_{c}.

The present invention relates to a method for managing the gloss of an organic coating applied on a moving strip on a coil-coating line. In particular, the moving strip is a metallic-coated steel strip.

### BACKGROUND

Coil coating is a continuous, automated process for coating metal before fabrication into end products. The steel or aluminum substrate is delivered in coil form from the rolling mills. The metal coil is positioned at the beginning of the coil-coating line and, in one continuous process, the coil is unwound, pre-cleaned, pre-treated, pre-primed, and pre-painted before being recoiled on the other end and packaged for shipment.

### SUMMARY OF THE INVENTION

The product obtained by this process is a pre-painted metal, also referred to as coil-coated metal, prefinished metal or pre-coated metal. It is commonly used in construction applications as well as appliances.

The paints traditionally used for coil-coating are solvent-based paints. Nevertheless, there has been a recent interest in radiation curing, which is the curing of materials using ultraviolet (UV processes) or electron beam (EB curing processes). The corresponding paints, known as radcure paints, are solvent-free and the curing process is triggered by either exposure to a high-energy UV light, possibly in conjunction with suitable photoinitiators, or exposure to accelerated electrons. Photoinitiators absorb UV light and generate free radicals. The latters react with double bonds of monomers causing chain reaction and polymerization. For UV-C and electron beam (EB) curing, initiators are not required. The high radiant energy produces sufficient reactive species (radicals) for polymerization to proceed spontaneously.

One of the specificities of radcure paints is to generate organic coatings with a high gloss due to high tension of the coating surface. To reduce this gloss and reach the requirements of the pre-painted markets (gloss typically between 15 and 30 GU for the construction market) paint suppliers add matting agents, as for solvent-based paints. However, the radcure paints being quite viscous due to the absence of solvent, only small amounts of matting agent can be added and it does not allow for low gloss levels. In addition, the migration of matting agents to the coating surface to achieve the desired gloss level is also very limited due to the speed of the curing process of radcure paints compared to solvent-based paints (1-2 seconds versus 12-25 seconds).

One way to mitigate this problem is known from WO81/00683 which discloses a curing process wherein the coating is first irradiated with curing radiation of wavelengths to which the coating is responsive but having substantially no distribution beneath about 300 nm (such as UV), and is subsequently irradiated with curing radiation of wavelengths to which the coating is responsive including substantial radiation at wavelengths beneath 300 nm (such as EB). This double curing is known as dualcure. Gloss control is obtained by adjusting on-line parameters including the spectral distribution, the intensity, or the dose of the initial radiation, or the time interval between the initial and subsequent irradiation steps.

It has nevertheless been observed that these on-line parameters are not enough to manage the gloss efficiently and in a reproducible way.

It is an object of the present invention to remedy the drawbacks of the process of the prior art by providing a method for managing, efficiently and in a reproducible way, the gloss of an organic coating formed by application and curing of a wet film of a radcure paint on a moving strip on a coil-coating line.

The present invention provides a method for managing the gloss of an organic coating formed by application and curing of a wet film of a radcure paint on a moving strip on a coil-coating line comprising, sequentially along the path P of the moving strip, a paint applicator, a cooling device comprising a cooling module, an Ultra-Violet curing device and an Electron-Beam curing device, the method comprising the steps of:
Setting a set gloss value Gₛ of the organic coating, a set gloss range Rₛ of the gloss of the organic coating and a proportionality constant K of a predefined linear mathematical relation between the temperature of the wet film before Ultra-Violet curing and the gloss of the organic coating after Electron-Beam curing,
Collecting the measure of the temperature T of the wet film in at least a width portion of the moving strip downstream of the cooling module and upstream of the Ultra-Violet curing device and collecting the measure of the gloss G of the organic coating in the at least a width portion downstream of the Electron-Beam curing device,
Correcting a deviation of the measured gloss G beyond the set gloss range Rₛ, this correcting step comprising a sub-step of calculating the corrected temperature T_{c} to be reached by the wet film, in the at least a width portion downstream of the cooling module and upstream of the Ultra-Violet curing device, according to equation 1:

$${T}_{c} = T + K ( G - {G}_{s} ) \qquad ( 1 )$$

and a sub-step of adjusting a setting of the coil-coating line taking into account the calculated corrected temperature T_{c}.

The method according to the invention may also have the optional features listed below, considered individually or in combination:
the cooling device is chosen among a forced-air cooler, a water spray cooler, a water-air fog spray cooler and a cooled roll,
the coil-coating line further comprises a heating device positioned between the paint applicator and the Ultra-Violet curing device,
The method further comprises an initial line setting step wherein:
   a plurality of process parameters and/or of specifications of the strip are collected,
   at least one initial line condition among the initial power PW₀ of the cooling module, the initial UV dose D₀ of the Ultra-Violet curing device and the initial length L₀ between the Ultra-Violet curing device and the Electron-Beam curing device is set, taking into account the process parameters and/or specifications of the strip that have been collected,
the sub-step of adjusting a setting of the coil-coating line comprises adjusting the power of the cooling module so that the wet film reaches the corrected temperature T_{c} in the at least a width portion of the moving strip downstream of the cooling module and upstream of the Ultra-Violet curing device,
the Ultra-Violet curing device comprises a UV module,
the setting step further comprises setting a minimum temperature Tₘᵢₙ for the radcure paint,
the collecting step further comprises collecting the UV dose D of the UV module,
the sub-step of adjusting a setting of the coil-coating line comprises:
   Evaluating if T_{c} is inferior to Tₘᵢₙ,
   If not, adjusting the power of the cooling module so that the wet film reaches the corrected temperature T_{c} in the at least a width portion of the moving strip downstream of the cooling module and upstream of the Ultra-Violet curing device,
   If T_{c} is inferior to Tₘᵢₙ:
      calculating the corrected UV dose D_{c} to which the wet film in the at least a width portion must be exposed in the UV module according to equation 2:

$${D}_{c} = {f}_{1} ( D , G , {G}_{s} ) \qquad ( 2 )$$

adjusting a setting of the coil-coating line other than the power of the cooling module, taking into account the calculated corrected UV dose D_{c},
the sub-step of adjusting a setting of the coil-coating line other than the power of the cooling module comprises adjusting the power of the UV module so that the wet film in the at least a width portion of the moving strip is exposed to the corrected UV dose D_{c},
the UV module is movable along the path P,
the setting step further comprises setting a minimum UV dose Dₘᵢₙ to which the wet film can be exposed in the UV module,
the collecting step further comprises collecting the length L between the UV module and the Electron-Beam curing device,
the sub-step of adjusting a setting of the coil-coating line other than the power of the cooling module comprises:
   Evaluating if D_{c} is inferior to Dₘᵢₙ,
   If not, adjusting the power of the UV module so that the wet film in the at least a width portion of the moving strip is exposed with the corrected UV dose D_{c},
   If D_{c} is inferior to Dₘᵢₙ:
      calculating the corrected length L_{c} between the UV module and the Electron-Beam curing device according to equation 3:

$${L}_{c} = {f}_{2} ( L , G , {G}_{s} ) \qquad ( 3 )$$

adjusting a setting of the coil-coating line other than the power of the cooling module and other than the power of the UV module, taking into account the calculated corrected length L_{c},
the sub-step of adjusting a setting of the coil-coating line other than the power of the cooling module and other than the power of the UV module comprises adjusting the length between the UV module and the Electron-Beam curing device to the corrected length L_{c} so that the gloss of value Gₛ is obtained on the organic coating in the at least a width portion of the moving strip downstream of the Electron-Beam curing device.

The present invention also provides a coil-coating line comprising sequentially a paint applicator, a cooling device comprising a cooling module, an Ultra-Violet curing device and an Electron-Beam curing device, the coil-coating line further comprising a gloss management tool for managing the gloss of an organic coating formed by application and curing of a wet film of a radcure paint on a moving strip on the coil-coating line, the gloss management tool comprising:
a setting module setting a set gloss value Gₛ of the organic coating, a set gloss range Rₛ of the gloss of the organic coating and a proportionality constant K of a predefined linear mathematical relation between the temperature of the wet film before Ultra-Violet curing and the gloss of the organic coating after Electron-Beam curing,
an acquisition module collecting the measure of the temperature T of the wet film in at least a width portion of the moving strip downstream of the cooling module and upstream of the Ultra-Violet curing device and collecting the measure of the gloss G of the organic coating in the at least a width portion downstream of the Electron-Beam curing device,
a correction module correcting a deviation of the measured gloss G beyond the set gloss range Rₛ, the correction comprising calculating the corrected temperature T_{c} to be reached by the wet film, in the at least a width portion downstream of the cooling module and upstream of the Ultra-Violet curing device, according to equation 1:

$${T}_{c} = T + K ( G - {G}_{s} ) \qquad ( 1 )$$

and adjusting a setting of the coil-coating line taking into account the calculated corrected temperature T_{c}.

Other characteristics and advantages of the invention will be described in greater detail in the following description.

### BRIEF DESCRIPTION OF THE DRAWINGS

The invention will be better understood by reading the following description, which is provided purely for purposes of explanation and is in no way intended to be restrictive, with reference to:

FIG. 1, which is a schematic representation of a coil-coating line,

FIG. 2, which is a flowchart of a first embodiment of the method according to the invention,

FIG. 3, which is a flowchart of a second embodiment of the method according to the invention, and

FIG. 4, which is a flowchart of a third embodiment of the method according to the invention.

### DETAILED DESCRIPTION

It should be noted that spatially relative terms such as “upstream”, “downstream”, “lower”, “upper”, “above”, “below”, “before”, “after”, et cetera as used in this application refer to the positions and orientations of the different constituent elements of the coil-coating line.

The method according to the invention is intended for strips, such as metallic strips. Steel, either carbon steel or stainless steel, aluminum, copper are examples of metallic strips. In particular, steel strips can be bare or coated with a metallic coating, on either one or two sides of the strip. Examples of possible metallic coated steels are galvanized steel, steels coated with a zinc alloy comprising 5 wt. % of aluminum (Galfan®), steels coated with a zinc alloy comprising 55 wt. % of aluminum, about 1.5 wt. % of silicon, the remainder consisting of zinc and inevitable impurities due to the processing (Aluzinc®, Galvalume®), steels coated with an aluminum alloy comprising from 8 to 11 wt. % of silicon and from 2 to 4 wt. % of iron, the remainder consisting of aluminum and inevitable impurities due to the processing (Alusi®), steels coated with a layer of aluminum (Alupur®), steels coated with a zinc alloy comprising 0.5 to 20% of aluminum, 0.5 to 10% of magnesium, the remainder consisting of zinc and inevitable impurities due to the processing, steels coated with an alloy comprising aluminum, magnesium, silicon, possible additional elements, the remainder consisting of zinc and inevitable impurities due to the processing.

The method according to the invention is also intended for radcure paints. The term “radcure paints” refers to radiation curable compositions that are “cured”, or dried, utilizing short wavelength ultraviolet (UV) light and/or high-energy electrons from electron-beam (EB) sources. They usually comprise liquid monomers and oligomers, into which pigments, fillers, additives, photoinitiators can be dispersed, generally without the need for either solvent or water. They are thus substantially solvent-free. Radcure paints for dualcure preferably comprise acrylate or methacrylate monomers and photoinitiators.

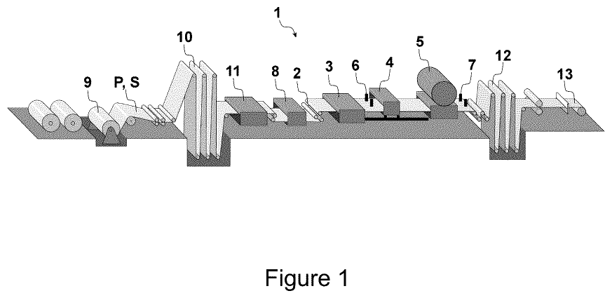

With reference to FIG. 1, the coil-coating line 1 according to the invention mainly comprises, sequentially along the path P of the moving strip, a paint applicator 2, a cooling device 3 comprising a cooling module, an Ultra-Violet curing device 4 and an Electron-Beam curing device 5.

The path P is the path followed by the strip S from its entry in the coil-coating line to its exit. It has a width and a length. Pieces of equipment are positioned along this path to perform operations on the strip.

A paint applicator 2 is a device that apply a wet film of paint on one or both sides of a strip with a set thickness of paint. In particular, its purpose is to apply the wet film of radcure paint. In the context of the invention, the technology of the paint applicator is not limited.

According to a variant of the invention, the paint applicator 2 is a paint roll-coater. It is an automated machine that coat one or both sides of a strip with rotating rolls. It is designed so that the strip passes through the machine that applies a layer of paint to one or both sides of the strip. There are numerous designs of paint roll-coaters depending on the configuration of the coil-coating line, the types of paints being used, and the types of strips being coated. The person skilled in the art will know which design is best adapted to each case. Generally speaking, the paint roll-coater comprises a paint pan, a steel or ceramic pick up roll, and a rubber covered coating roll. The purpose of the paint pan is to contain, circulate and preferably heat the paint. The pick up roll can be partially immersed in the paint and can rotate in either a clockwise or a counter clockwise direction to pick the paint up and transfer it to the coating roll. The latter transfers the paint to the strip.

According to another variant of the invention, the paint applicator 2 is a curtain coater. In that case, a curtain of paint is applied to the horizontal strip normally transverse to the curtain. The paint falls from a height under gravity from a curtain die or cascade while the strip is supported on a backing roller. This method is capable of achieving high line speeds and multilayer coatings.

Examples of other paint applicators are knife coater, dip or meniscus coater, slot coater, meter rod coater, or slide coater.

The paint is usually applied with the paint applicator on the full width of the strip. By default, the width of the wet film of paint, and consequently of the organic coating, is the same as the strip width.

The paint applicator 2 is preferably equipped with at least one paint heating device suitable for heating and maintaining the paint at a set temperature. Heating the paint facilitates its application. In the case of a paint roll-coater, the paint heating device can be a pan heater, i.e. a heater positioned in or around the paint pan. It can also be a temperature-controlled roll, in particular a temperature-controlled pick-up roll, possibly in combination with the pan heater. In the case of a curtain coater, the paint heating device can be a heater positioned upstream of the curtain die. It can also be a temperature-controlled backing roll, possibly in combination of the heater.

The paint applicator 2 is preferably equipped with a temperature measuring device for measuring the paint temperature and/or the wet film temperature at the level of the paint applicator. The temperature device can be, for example, a temperature sensor, a pyrometer, or a thermal camera.

The coil-coating line 1 further comprises a cooling device 3 comprising a cooling module, positioned, along the path P of the moving strip, downstream of the paint applicator 2 and upstream of the Ultra-Violet (UV) curing device 4. Its purpose is to cool the wet film of radcure paint, notably when the wet film is applied on a strip that is still warm from the previous step (e.g. curing of a primer coating in an oven or galvanizing) or when the ambient temperature is warm, for example in summer time. The cooling device improves the temperature control of the wet film of paint before its surface is cured in the UV curing device by alleviating the variations of the temperature of the wet film entering the UV curing device that would otherwise occur as a result of line variations. Indeed, as the temperature of the strip exiting the paint applicator decreases at a rate that depends on a number of parameters (strip nature, strip width, strip thickness, line speed, ambient temperature . . . ), the temperature of the wet film entering the UV curing device may vary significantly from time to time, which would impact the gloss detrimentally. Thanks to the cooling device, the temperature of the wet film can be adjusted.

The cooling device is preferably chosen among a forced-air cooler, a water spray cooler, a water-air fog spray cooler and a cooled roll. In the case of water-based coolers, as the wet film of radcure paint is applied on the top side of the strip, water is preferably put in contact with the back side of the strip only. The cooling device is not a water tank.

According to one variant, the cooling device is made of one cooling module covering the full width of the path P of the moving strip. In that case, the wet film is cooled uniformly along its width when passing (through) the cooling device.

According to another variant, the cooling device 3 comprises a plurality of cooling modules distributed in the width of the path P. In other words, the plurality of cooling modules forms a row substantially parallel to the width of the path P, i.e. perpendicular to the moving direction of the strip. For the sake of clarity, the cooling modules described here are independent of each other and positioned adjacent to each other but they can be physically inseparable from each other. They can be individually controllable portions of a single cooling device.

The cooling modules are preferably chosen among a forced-air cooler, a water spray cooler, a water-air fog spray cooler and a cooled roll.

Thanks to this design, temperature variations in the strip width can be corrected and minimized. Preferably, the temperature variation of the wet film in the strip width at the exit of the cooling device is below 1° C. It improves the gloss homogeneity of the coating in the strip width.

According to another variant, the cooling device 3 comprises sequentially along the path of the moving strip a base cooler covering the full width of path P and the plurality of cooling modules described above. The base cooler can be a forced-air cooler, a water spray cooler, a water-air fog spray cooler and a cooled roll. Thanks to this design, a part of the cooling needed to reach the correct temperature of the wet film at the exit of the cooling device is provided by the base cooler. Each cooling module of the plurality of cooling modules independently provides the remaining part of the cooling and can adjust it as requested.

The cooling device 3 is preferably positioned above the path P so that the wet film applied on the top side of the strip is directly cooled. The cooling device can also be positioned above and below the path P to minimize thermal gradients.

The coil-coating line 1 further comprises an Ultra-Violet (UV) curing device 4. The purpose of this equipment is to cure the surface of the wet film of radcure paint. It has been observed that this surface curing generates a very fine texturing at the film surface which, combined with mating agents and possible other charges, contribute to the gloss of the organic coating once the wet film has been fully cured by Electron-Beam.

According to one variant, the UV curing device 4 covers the full width of the path P of the moving strip. In that case, the surface of the wet film is cured uniformly along the strip width when exposed to UV.

According to another variant, the UV curing device 4 comprises a plurality of UV modules distributed in the width of the path P. In other words, the plurality of UV modules forms a row substantially parallel to the width of the path P, i.e. perpendicular to the moving direction of the strip. For the sake of clarity, the UV modules described here are independent of each other and positioned adjacent to each other but they can be physically inseparable from each other. They can be individually-controllable portions of a single UV curing device.

Thanks to this design, different width portions of the path/strip can be exposed to different UV doses. It helps correcting and minimizing gloss variations in the strip width. Accordingly, the cooling device preferably comprises a plurality of cooling modules forming a row substantially parallel to the width of the path P, each cooling module been suited for cooling a width portion of the strip which is then exposed to the UV of one UV module. In other words, each width portion covered by a given UV module corresponds to the width portion covered by a corresponding cooling module.

UVA and UVB are preferred. UVA is long-range UV radiation between 320 and 400 nm. UVB is short-wave UV radiation between 280 and 320 nm. They can be obtained with conventional arc UV lamps.

The UV curing device 4 is preferably movable along the path P of the moving strip. It allows the length between the UV curing device and the EB curing device to be adjusted, i.e. extended or shortened. It has indeed been observed that the wrinkles or surface roughness initiated during the UV curing is further developed during the time interval between UV curing and EB curing, which impacts the gloss of the organic coating.

In the case of a plurality of UV modules, each UV module is preferably movable along the path P independently of the others.

The coil-coating line 1 further comprises an Electron-Beam curing device 5. The purpose of this equipment is to cure the wet film of radcure paint, i.e. in its full thickness. It further freezes the surface roughness which appears at the surface of the wet film during UV curing and which further develops during the time interval between UV curing and EB curing. The EB device is generally operated in the following conditions: 100-200 kV, 20-50 kGy, inerting with nitrogen below 200 ppm O₂.

The coil-coating line 1 further comprises a wet film temperature measuring device 6 positioned downstream of the cooling device 3 and upstream of the UV curing device 4. This wet film temperature measuring device measures the temperature of the wet film before it enters the UV curing device. It can measure the temperature of the wet film along the whole width of the path P of the moving strip or it can measure the temperature on only a portion of the width. Examples of wet film temperature measuring devices are pyrometer, thermal camera, thermocouple. The measured temperature can be expressed in ° C., ° F. or K.

In the case where the wet film temperature measuring device measures the temperature on only a portion of the width, the measure on this portion can be considered relevant enough to manage the gloss of the whole strip width.

Alternatively, a plurality of wet film temperature measuring devices is positioned downstream of the cooling device 3 and upstream of the UV curing device so that the whole width of the path P of the moving strip is covered. They form a row substantially parallel to the width of the path P. Accordingly, the cooling device preferably comprises a plurality of cooling modules forming a row substantially parallel to the width of the path P, each cooling module been suited for cooling a width portion of the strip whose temperature is then measured by one wet film temperature measuring device.

In order to further increase the temperature control of the wet film in the UV curing device, the wet film temperature measuring device 6 and the UV curing device 4 are not separated by more than 2 meters, preferably not by more than 1 meter, or the temperature of the wet film is not measured more than 4 seconds before the wet film is cured in the UV curing device, preferably not more than 2 seconds. Alternatively or in addition, the portion of the path P of the moving strip between the wet film temperature measuring device and the UV curing device can be thermally insulated to keep the wet film at the measured temperature before it is cured in the UV curing device.

The coil-coating line 1 further comprises a gloss measuring device 7 positioned downstream of the Electron-Beam curing device 5. This gloss measuring device measures the gloss of the organic coating after EB curing. It can measure the gloss of the organic coating along the whole width of the path P of the moving strip or it can measure the gloss on only a portion of the width. Examples of gloss measuring devices are glossmeters. The measured gloss is preferably expressed in GU (Gloss Units). The gloss is preferably measured in accordance with standards ISO 2813:2014 and EN 13523-2:2021. Preferably, the gloss is measured with a 20° geometry, a 60° geometry or an 85° geometry, i.e. the reflection angle is either 20°, 60° or 85°. More preferably, the gloss is measured with a 60° geometry.

In the case where the gloss measuring device measures the gloss on only a portion of the width, the measure on this portion can be considered relevant enough to manage the gloss of the whole strip width.

Alternatively, a plurality of gloss measuring devices is positioned downstream of the EB curing device so that the whole width of the path P of the moving strip is covered. They form a row substantially parallel to the width of the path P. Accordingly, the cooling device preferably comprises a plurality of cooling modules forming a row substantially parallel to the width of the path P, each cooling module been suited for cooling a width portion of the strip whose gloss is then measured by one gloss measuring device. Accordingly, the UV curing device preferably comprises a plurality of UV modules forming a row substantially parallel to the width of the path P, each UV module been suited for exposing to UV a width portion of the strip whose gloss is then measured by one gloss measuring device.

The coil-coating line 1 is preferably equipped with a strip speed measuring device, more preferably positioned at the level of a guiding roll. An example of strip speed measuring device is a tachymeter integrated on roll axis.

The coil-coating line 1 can further comprise an inductor 8 upstream of the paint applicator 2. It can heat the strip before it reaches the paint applicator. Having a warm strip in the paint applicator favors the paint application. Furthermore, the temperature reached by the strip in the inductor can be adjusted to correct possible gloss deviations, as it will be described in detail later.

The coil-coating line 1 can further comprise an entry section with an uncoiler 9 to uncoil the strip to be coated on the line. The uncoiler can be combined with a welding machine or a stitching machine so that the front end of the strip to be coated can be attached to the tail end of the previous strip.

Alternatively, the coil-coating line can be coupled to a galvanizing line so that the strip coated with the metallic alloys contained in the bath of the galvanizing line is directly coated with the organic coating without having to first coil it and then uncoil it.

The coil-coating line 1 can further comprise an entry accumulator 10 located in the entry section of the line, downstream of the uncoiler if applicable. The accumulator is a piece of equipment that “accumulates” a certain amount of strip. It is a set of upper and lower banks of rolls through which the metal strip is threaded in a serpentine fashion, and it stores lengths of metal as the two roll banks are spread apart. The total stored length of metal depends on the design speed of the line, usually 60 seconds of steady-state metal processing time. When the entry section of the coil-coating line stops, the roll banks move toward each other, and the stored metal in the accumulator continues to feed the rest of the coil-coating line.

The coil-coating line 1 can further comprise a cleaning section 11, positioned downstream of the entry section, in particular downstream of the entry accumulator if applicable. In this section, the strip is subjected to a surface preparation step. This type of preparation comprises at least one step selected among rinsing, degreasing and a conversion treatment. The purpose of the rinsing is to eliminate the loose particles of dirt, potential residues of conversion solutions, soaps that may have formed and to achieve a clean and reactive surface. The purpose of the degreasing is to clean the surface by removing all traces of organic dirt, metallic particles and dust from the surface. Preferably, the degreasing is performed in an alkaline environment. The conversion treatment includes the application on the strip of a conversion solution that reacts chemically with the surface and thereby makes it possible to form a conversion layer. The latter increases the adherence of the paint and the corrosion resistance. The conversion treatment is preferably an acid solution that does not contain chromium. More preferably, the conversion treatment is based on hexafluorotitanic acid or hexafluorozirconic acid.

The coil-coating line 1 can further comprise a primer section, upstream of the paint applicator 2 and downstream of the cleaning section if applicable. In this section, a first layer of paint can be applied on the strip to form a primer coating. The primer section can comprise a primer paint applicator and a curing equipment. Depending on the nature of the primer, the curing equipment can be an oven, such as a convection oven, an infra-red (or near infra-red) oven or an induction oven, a UV curing device and/or an EB curing device.

The coil-coating line 1 can further comprise an exit accumulator 12 located in the exit section of the line, downstream of the EB curing device. The exit accumulator is similar to the entry accumulator described above.

The coil-coating line 1 can further comprise a recoiler 13 to recoil the strip which has been coated on the line. The recoiler can be combined with a cut-off to separate the strip from the next one processed on the line.

The coil-coating line 1 can further comprise a heating device, positioned, along the path P of the moving strip, adjacent to the cooling device. The heating device can be positioned either upstream or downstream of the cooling device. Its purpose is to take over from the cooling device when the wet film of paint is not warm enough before its surface is cured in the UV curing device, although the cooling device is at minimum or turned off. Thanks to the heating device, the temperature of the wet film can be adjusted more precisely than with the cooling device only.

The heating device is preferably chosen among an infrared heater, an induction heater, a convector, a forced-air heater, a water spray heater, a water-air fog spray heater and a heated roll. Preferably the heating device is an infrared heater. In the case of water-based heaters, as the wet film of radcure paint is applied on the top side of the strip, water is preferably put in contact with the back side of the strip only.

According to one variant, the heating device is made of one heating module covering the full width of the path P of the moving strip. In that case, the wet film is heated uniformly along its width when passing (through) the heating device.

According to another variant, the heating device comprises a plurality of heating modules distributed in the width of the path P. In other words, the plurality of heating modules forms a row substantially parallel to the width of the path P, i.e. perpendicular to the moving direction of the strip. For the sake of clarity, the heating modules described here are independent of each other and positioned adjacent to each other but they can be physically inseparable from each other. They can be individually controllable portions of a single heating device.

The heating modules are preferably chosen among an infrared heater, induction heater, a convector, a forced-air heater, a water spray heater, a water-air fog spray heater and a width portion of a heated roll. More preferably, the heating modules are infrared heaters.

Thanks to this design, temperature variations in the strip width can be corrected and minimized. Preferably, the temperature variation of the wet film in the strip width at the exit of the heating device is below 1° C. It improves the gloss homogeneity of the coating in the strip width.

According to another variant, the heating device comprises sequentially along the path of the moving strip a base heater covering the full width of path P and the plurality of heating modules described above. Thanks to this design, a part of the energy needed to reach the correct temperature of the wet film at the exit of the heating device is provided by the base heater. Each heating module of the plurality of heating modules independently provides the remaining part of the energy and can adjust it as requested.

The heating device is preferably positioned above the path P so that the wet film applied on the top side of the strip is directly heated. The heating device can also be positioned above and below the path P to minimize thermal gradients.

The invention also relates to a gloss management tool for managing the gloss of an organic coating formed by application and curing of a wet film of a radcure paint on a moving strip on a coil-coating line 1 comprising, sequentially along the path P of the moving strip S, a paint applicator 2, a cooling device 3 comprising a cooling module, an Ultra-Violet curing device 4 and an Electron-Beam curing device 5.

The gloss management tool comprises a setting module for setting a set gloss value Gₛ of the organic coating, a set gloss range Rₛ of the gloss of the organic coating and a proportionality constant K of a predefined linear mathematical relation between the temperature of the wet film before Ultra-Violet curing and the gloss of the organic coating after Electron-Beam curing.

The gloss management tool further comprises an acquisition module configured for collecting the measure of the temperature T of the wet film in at least a width portion of the moving strip downstream of the cooling module and upstream of the Ultra-Violet curing device and for collecting the measure of the gloss G of the organic coating in the at least a width portion downstream of the Electron-Beam curing device.

The gloss management tool further comprises a correction module configured for correcting a deviation of the measured gloss G beyond the set gloss range Rₛ, the correction comprising calculating the corrected temperature T_{c} to be reached by the wet film in the at least a width portion downstream of the cooling module and upstream of the Ultra-Violet curing device according to equation 1:

$${T}_{c} = T + K ( G - {G}_{s} ) \qquad ( 1 )$$

and adjusting a setting of the coil-coating line taking into account the calculated corrected temperature T_{c}.

The gloss management tool can include a processing unit formed for example of a memory and of a processor coupled to the memory. The electronic monitoring device may also include a display screen and input/output means, such as a keyboard and a mouse, each being connected to the processing unit. Each of the setting module, acquisition module and correction module can be implemented, as a software executable by the processor.

The coil-coating line is preferably equipped with the gloss management tool to ease the management of the gloss on the coil-coating line.

From a process perspective, the management of the gloss of an organic coating formed by application and curing of a wet film of a radcure paint on a moving strip on the coil-coating line described above is primarily based on the discovery that the temperature of the wet film before UV curing is key. In particular, the inventors have observed that, in dualcure for coil-coating, there is a linear relationship between the temperature of the wet film before UV curing and the gloss of the organic coating after EB curing. Consequently, any deviation of the gloss after EB curing can be efficiently and reproducibly corrected by adjusting the temperature of the wet film before UV curing.

The method is applied on a moving strip. The strip can be one single coil which is unwounded at the entry of the coil-coating line. More generally, the strip is composed of different coils attached to one another end to end. The coils form one essentially continuous strip whose features and technical specifications to be reached at the exit of the coil-coating line vary over time. The strip is moved along the path P of the coil-coating line so that the wet film of radcure paint is applied, preferably cooled, and double cured. In particular, the strip is moved along the path P of the coil-coating line so that the wet film of radcure paint is first applied on the strip by the paint applicator, then cooled by the cooling module, then exposed to UV in the Ultra-Violet curing device and finally cured in the Electron-Beam device. Optionally, the strip can be preheated with an inductor 8 positioned upstream of the paint applicator 2. Optionally, the radcure paint can be heated in the paint applicator.

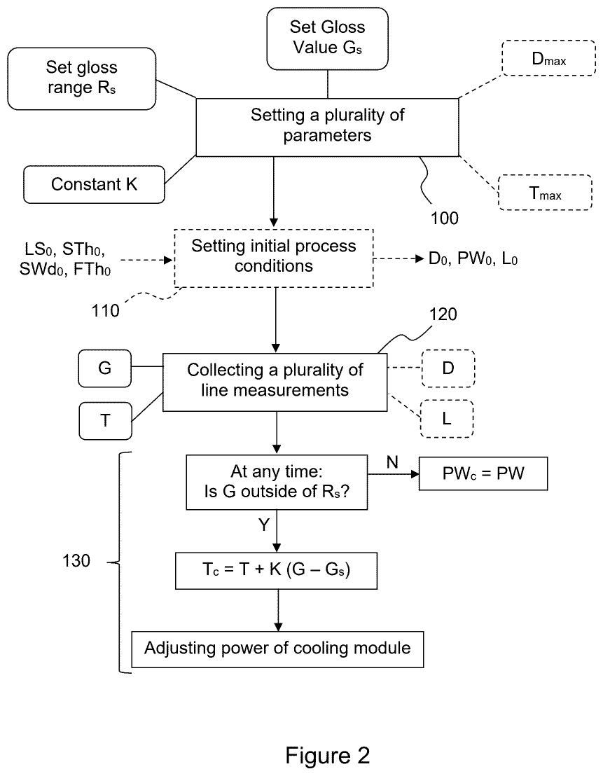

A first embodiment of the method is described with reference to FIG. 2.

The first step 100 of the method for managing the gloss is the setting of some set values needed for a correct regulation.

The set gloss value Gₛ of the organic coating is first set. This value corresponds to the gloss requested by the customer or by the operator of the coil-coating line. From a practical point of view, it can be manually entered in the gloss management tool, in particular in the setting module. Alternatively, it can be automatically obtained from the order book of the coil-coating line, in particular from the scheduling tool.

As slight deviations of the gloss along the length of the strip are usually acceptable from a quality perspective, a set gloss range Rₛ of the gloss of the organic coating is also set. It can be entered as a range as such, with a minimal gloss and a maximal gloss or it can be entered as a standard deviation of the set gloss value Gₛ. Of course, if for some reason, slight deviations have to be avoided, the set gloss value Gₛ can be entered as the minimal gloss and the maximal gloss or the standard deviation can be set at zero. From a practical point of view, the set gloss range Rₛ can be manually entered in the gloss management tool, in particular in the setting module. Alternatively, it can be automatically obtained from the management tool of the coil-coating line or from the order book of the coil-coating line, in particular from the scheduling tool. The set gloss range Rₛ of the gloss can also be obtained from standards, such as EN10169: 2013.

Also, as the gloss management relies on the linear mathematical relation between the temperature of the wet film before Ultra-Violet curing and the gloss of the organic coating after Electron-Beam curing, the proportionality constant K of this linear mathematical relation has to be set so that the regulation is correct.

The proportionality constant K can be obtained in a calibration step performed ahead of the setting step. During this calibration step, wet films of the radcure paint to be used on the coil-coating line are heated at different temperatures, cured by dualcure in standard curing conditions and the gloss of the organic coatings is measured. The proportionality constant K can thus be deducted. It is preferably expressed in ° C./GU, ° F./GU or K/GU, depending on the temperature unit. This calibration step can be done once and for all and does not have to be performed each time the method according to the invention is implemented.

From a practical point of view, the proportionality constant K is obtained from a predefined linear mathematical relation between the temperature of the wet film before Ultra-Violet curing and the gloss of the organic coating after Electron-Beam curing, the predefined linear mathematical relation being available to the operator of the coil-coating line. In particular, K is the proportionality constant of the linear mathematical relation T=T₀−K G. By “predefined”, it is meant that a calibration step, preferably as described above, has been performed before implementing the method on the coil-coating line. The proportionality constant K can be manually entered in the gloss management tool, in particular in the setting module. Alternatively, it can be automatically obtained by crossing the predefined linear mathematical relations entered in the gloss management tool, possibly in the form of a table, with the paint reference from the order book of the coil-coating line, in particular from the scheduling tool.

For example, it has been observed that for radcure paints commercially available for coil-coating of steel, K is usually comprised between 0.3 and 1.2.

In a second step 120 of the method for managing the gloss, the measure of the temperature T of the wet film in at least a width portion of the moving strip downstream of the cooling module and upstream of the Ultra-Violet curing device is collected and the measure of the gloss G of the organic coating in the at least a width portion downstream of the Electron-Beam curing device is collected.

Preferably, the temperature is measured with a wet film temperature measuring device as described above and the gloss is measured with a gloss measuring device as described above.

Preferably, both measures are done at time intervals short enough to have a proper management of the gloss. Examples of time intervals are less than 30 s, less than 20 s, less than every 10 s, less than every 5 s, less than every 2 s, less than every second. More preferably, both measures are substantially continuous or continuous. Preferably, both measures are collected at time intervals short enough to have a proper management of the gloss. Examples of time intervals are less than every 10 s, less than every 5 s, less than every 2 s, less than every second. More preferably, both measures are collected substantially continuously or continuously. Preferably, the measurements are collected in the gloss management tool, in particular in the acquisition module, more preferably automatically with the appropriate interface.

By “width portion”, it is meant that the moving strip is conceptually divided in portions adjacent to one another in the strip width. There can be one single width portion or a plurality. Consequently, the wet film and the organic coating can also be conceptually divided in the same width portions. By “at least a width portion”, it is meant that the method is implemented either on one width portion or on a plurality of width portions or on the full width of the moving strip. In the case where it is not implemented at full width, it is thus possible to measure and collect:
the temperature T of the wet film in one single width portion if the measure in this width portion is considered representative enough of the mean temperature over the whole strip width, or
the temperatures of the wet film in a plurality of width portions so that the temperature in each width portion can be adjusted independently of the other portions.

Similarly, it is thus possible to measure and collect:
the gloss G of the organic coating in one single width portion if the measure in this width portion is considered relevant enough to manage the gloss of the whole strip width, or
the glosses of the organic coating in a plurality of width portions so that the gloss in each width portion can be managed independently of the other portions.

In one variant, the collecting step is performed after the setting step.

In another variant, in particular during a continuous operation of the coil-coating line, the collecting step can be done in parallel to the setting step. In such case of continuous operation, as the strip is composed of different coils attached to one another end to end, changes in the features of the strip and changes in the technical specifications of the strip often happen. While the collecting step is in progress, any one of the set parameters, in particular any one of the set gloss value Gₛ, the set gloss range Rₛ and/or the constant K, may have to be modified for some reason, like a change of specified gloss or a change in radcure paint. Consequently, the setting step is performed.

In a third step 130 of the method for managing the gloss, a possible deviation of the measured gloss G beyond the set gloss range Rₛ is corrected. At first, a possible deviation of the gloss is assessed by comparing the measured gloss G to the set gloss value Gₛ and/or to the set gloss range Rₛ. If the measured gloss G is still within the set gloss range Rₛ, the settings are maintained. If the measured gloss G has deviated beyond the set gloss range Rₛ, the corrected temperature T_{c} to be reached by the wet film in the at least a width portion of the moving strip downstream of the cooling module and upstream of the Ultra-Violet curing device is calculated according to equation 1:

$${T}_{c} = T + K ( G - {G}_{s} ) \qquad ( 1 )$$

The assessment of the gloss deviation can be done at any time. Preferably, it is done at time intervals short enough to have a proper management of the gloss. Examples of time intervals are less than 30 s, less than 20 s, less than every 10 s, less than every 5 s, less than every 2 s, less than every second. More preferably, the assessment is substantially continuous or continuous.

Once the corrected temperature has been calculated, the result of the calculation, i.e. corrected temperature T_{c}, is preferably made available to a line operator. The latter can make the necessary corrections.

Generally speaking, a line setting is adjusted taking into account the calculated corrected temperature T_{c}, so that the gloss of value Gₛ is obtained on the organic coating in the at least a width portion of the moving strip downstream of the Electron-Beam curing device. In particular, a line setting is adjusted so that the wet film reaches the corrected temperature T_{c} in the at least a width portion of the moving strip downstream of the cooling module and upstream of the Ultra-Violet curing device.

In a first variant illustrated in FIG. 2, once the corrected temperature has been calculated, the power of the cooling module is adjusted so that the wet film reaches the corrected temperature T_{c} in the at least a width portion of the moving strip downstream of the cooling module and upstream of the Ultra-Violet curing device. Adjusting the power of the cooling module includes turning the cooling module on or off. Thanks to the adjustment of the cooling module, the temperature of the wet film in the width portion downstream of the cooling module and upstream of the Ultra-Violet curing device is corrected and gloss of value Gₛ is obtained on the organic coating in the width portion downstream of the Electron-Beam curing device. The adjustment of the power of the cooling module can be done either manually by an operator or automatically with the help of the gloss management tool, in particular of the correction module.

Alternatively, in the case where the coil-coating line is equipped with a heating device comprising a heating module and adjacent to the cooling device, once the corrected temperature has been calculated, the heating module is turned on and its power is adjusted so that the wet film reaches the corrected temperature T_{c} in the at least a width portion of the moving strip downstream of the cooling module/heating module and upstream of the Ultra-Violet curing device. This alternative way of correcting the gloss is helpful notably in the case where the cooling module is already at minimum capacity or off and the temperature of the wet film upstream of the Ultra-Violet curing device has to be further increased.

Alternatively, in the case where the coil-coating line is equipped with an inductor upstream of the paint applicator, once the corrected temperature has been calculated, the power of the inductor is adjusted so that the temperature of the strip at the level of the paint applicator is adjusted so that the wet film reaches the corrected temperature T_{c} in the at least a width portion of the moving strip downstream of the cooling module and upstream of the Ultra-Violet curing device. This alternative way of correcting the gloss is helpful notably in the case where the cooling module is already at minimum capacity or off and the temperature of the wet film upstream of the Ultra-Violet curing device has to be further increased.

In one variant, the correcting step 130 is performed after the collecting step 120.

In another variant, in particular during a continuous operation of the coil-coating line, the correcting step can be done in parallel to the collecting step. In such case of continuous operation, as the strip is composed of different coils attached to one another end to end, changes in the features of the strip and changes in the technical specifications of the strip often happen. They can make the gloss deviate. While the collecting step is in progress, the correcting step is performed to correct the measured gloss.

Optionally, the method further comprises a step 110 during which initial line conditions are set. This step is referred to as the initial line setting step. As explained above, the method is such that any deviation of the measured gloss beyond the set gloss range Rₛ is corrected. That said, at the start of a production campaign on the coil-coating line or after an important change in, for example, the strip format, the paint thickness, the paint color or the line speed, the line conditions might be shifted from the line conditions appropriate for reaching the set gloss value Gₛ. In such case, the cooling module may not cool appropriately and/or may need some time to reach the power corresponding to the corrected temperature T_{c} and/or may not be powerful enough to allow the wet film to reach the corrected temperature T_{c}. Consequently, a portion of the coated strip may have to be scrapped because the gloss is out of the specifications. Moreover, the UV dose to which the wet film must be exposed to initiate the surface roughness that will bring the set gloss value may not be appropriate. In such case, the cooling module needs to compensate for the shifted UV dose, possibly by cooling strongly, which takes time. Here again, a portion of the coated strip may have to be scrapped because the gloss is out of the specifications. In order to minimize the length of coated strip out of specifications, it is advantageous to set initial line conditions.

To do so, in a first sub-step, a plurality of process parameters and/or of specifications of the coated strip are collected. An example of process parameters is the initial line speed LS₀. It is preferably the one recommended for the next coil to be coated on the coil-coating line. Another example is the initial thickness FTh₀ of the wet film applied on the strip by the paint applicator. The initial film thickness is preferably the one that corresponds to the organic coating thickness specified for the next coil to be coated on the coil-coating line. Another example is the temperature of the moving strip before the paint applicator, preferably before the inductor. Examples of specifications are the initial strip thickness STh₀, the initial strip width SWd₀, the paint color. Preferably, the initial line speed LS₀, initial thickness FTh₀, the initial strip thickness STh₀, the initial strip width SWd₀ and the paint color are collected. From a practical point of view, process parameters and/or specifications can be manually entered in the gloss management tool, in particular in the setting module. Alternatively, they can be automatically obtained from the order book of the coil-coating line, in particular from the scheduling tool and/or deducted from the order book. For example, the initial film thickness FTh₀ can be deducted from the organic coating thickness specified in the order book.

Once process parameters and/or specifications have been collected, in a second sub-step, the initial line conditions are set taking into account the process parameters and/or specifications that have been collected. In particular, they are calculated from the process parameters and/or specifications that have been collected. The following initial line conditions can be set:
the initial power PW₀ of the cooling module,
the initial UV dose Do of the Ultra-Violet curing device, or of the UV module if applicable,
the initial length L₀ between the Ultra-Violet curing device, or the UV module if applicable, and the Electron-Beam curing device.

The initial power PW₀ can be set knowing the mass flow of the moving strip, the specific heat capacity of the strip and the cooling yield. The initial UV dose Do can set based on data obtained in a calibration step performed ahead of the initial line setting step. The initial length L₀ can be set based on data obtained in a calibration step performed ahead of the initial line setting step.

From a practical point of view, the initial line conditions can be manually entered in the management tool of the coil-coating line. Alternatively, they can be automatically injected by the gloss management tool in the management tool of the coil-coating line.

In one variant, the initial line setting step 110 is performed before the setting step 100. It helps starting the production with line conditions that are already optimized for the first coil of the production campaign, in addition to an initial combination of set gloss value Gₛ, set gloss range Rₛ and constant K. During production, the collecting step and the correcting step can be performed to manage the gloss. When any one of the set parameters, in particular any one of the set gloss value Gₛ, the set gloss range Rₛ and/or the constant K, has to be modified for some reason, like a change of specified gloss or a change in radcure paint, then it is relied on the performance of the collecting step 120 and the correcting step 130 to keep the measured gloss within the set gloss range Rₛ.

In another variant, the initial line setting step 110 is performed after the setting step 100, as illustrated in FIG. 2. This way the setting of the initial line conditions can be done by taking the set gloss value Gₛ into account. The line conditions are thus better optimized for the first coil of the production campaign. Moreover, during production, when any one of the set parameters, in particular any one of the set gloss value Gₛ, the set gloss range Rₛ and/or the constant K has to be modified for some reason, the initial line settings can be reset to help minimizing the transitional period.

In another variant, the initial line setting step 110 is performed before and after the setting step 100 to take advantages of both variants described above.

In another variant, in particular during a continuous operation of the coil-coating line, the initial line setting step can be done in parallel to the collecting step. In such case of continuous operation, as the strip is composed of different coils attached to one another end to end, changes in the features of the strip and changes in the technical specifications of the strip often happen. Re-initializing the line conditions when one of these changes occurs helps to reach the set gloss value as fast as possible.

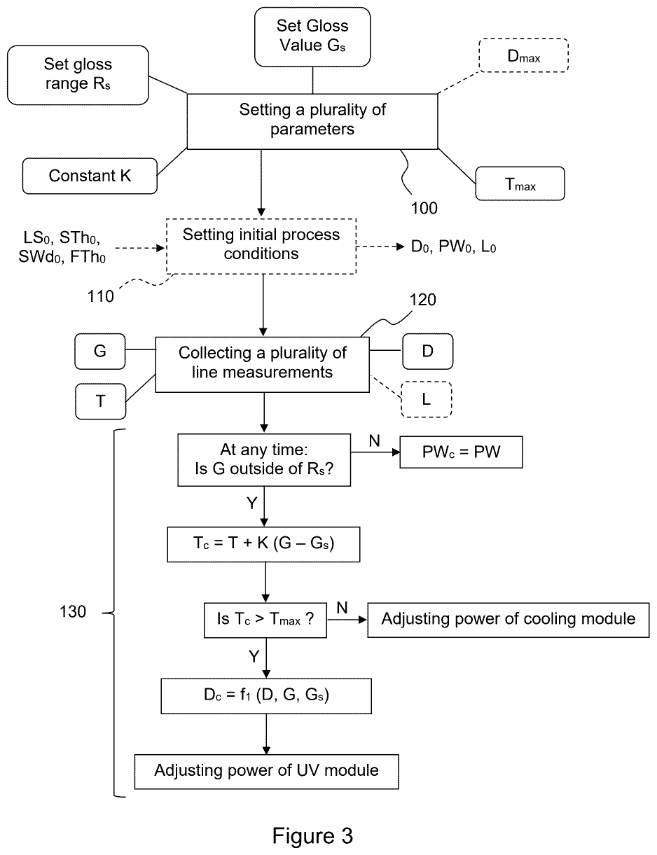

A second embodiment of the method is now described with reference to FIG. 3.

This embodiment mainly differs from the first one in that the correcting step comprises additional sub-steps to:
ensure that the calculated corrected temperature T_{c} is not below a minimum temperature Tₘᵢₙ that would block diffusion and/or mobility phenomena and,
correct the deviation of the measured gloss G accordingly.

Thanks to this configuration, it is better ensured that the wet film will react appropriately to the UV exposure.

The details provided when describing the first embodiment apply to the second embodiment as well. The additional steps and corresponding features are described in detail now.

The setting step 100 further comprises setting a minimum temperature Tₘᵢₙ for the radcure paint. This temperature can be the one recommended by the paint supplier. It can alternatively be identified during a calibration step performed ahead of the setting step. During this calibration step, wet films of the radcure paint to be used on the coil-coating line are cooled at different temperatures, cured by dualcure in standard curing conditions and the gloss of the organic coatings is measured. The temperature at which the wet film does not react to the UV exposure can be set as Tₘᵢₙ. From a practical point of view, the minimum temperature Tₘᵢₙ can be manually entered in the gloss management tool, in particular in the setting module. Alternatively, it can be automatically obtained by crossing the different minimum temperatures entered in the gloss management tool with the paint reference from the order book of the coil-coating line, in particular from the scheduling tool.

The collecting step 120 further comprises collecting the UV dose D of the UV module. The power of the UV module is generally known from the operator, possibly from the management tool of the coil-coating line, but, for a given power, the actual UV dose to which the wet film is exposed varies with the line speed LS. Accordingly, the UV dose is calculated based on the power of the UV module and the line speed and collected. The line speed itself is generally known from the operator, possibly from the management tool of the coil-coating line.

Preferably the UV dose is re-calculated and collected each time either the power of the UV module and/or the line speed is adjusted. More preferably, the collection of the UV dose is substantially continuous. Preferably, the UV dose is collected in the gloss management tool, in particular in the acquisition module, more preferably automatically with the appropriate interface.

During the correcting step 130, once the corrected temperature T_{c} has been calculated, it is compared to the minimum temperature Tₘᵢₙ. If T_{c} is superior to Tₘᵢₙ, then the power of the cooling module is adjusted so that the wet film reaches the corrected temperature T_{c} in the at least a width portion of the moving strip downstream of the cooling module and upstream of the Ultra-Violet curing device, as in the first embodiment. Alternatively, in the case where the coil-coating line is equipped with a heating device comprising a heating module and adjacent to the cooling device, once the corrected temperature has been calculated, the power of the heating module is adjusted so that the wet film reaches the corrected temperature T_{c} in the at least a width portion of the moving strip downstream of the cooling module/heating module and upstream of the Ultra-Violet curing device. The adjustment of the power of the heating module includes turning it on. Alternatively, in the case where the coil-coating line is equipped with an inductor upstream of the paint applicator, once the corrected temperature has been calculated, the power of the inductor is adjusted so that the temperature of the strip at the level of the paint applicator is adjusted so that the wet film reaches the corrected temperature T_{c} in the at least a width portion of the moving strip downstream of the cooling module and upstream of the Ultra-Violet curing device.

If T_{c} is inferior to Tₘᵢₙ, then the gloss has to be corrected without increasing the power of the cooling module any further. One way to do so is to adjust, in particular to lower, the power of the UV module. It has indeed been observed that it impacts the gloss of the organic coating. The lower the UV dose on the wet film, the higher the gloss. Consequently, the correcting step 130 further comprises calculating the corrected UV dose D_{c} to which the wet film in the at least a width portion of the moving strip must be exposed in the UV module according to equation 2:

$${D}_{c} = {f}_{1} ( D , G , {G}_{s} ) \qquad ( 2 )$$

Equation (2) can be obtained in a calibration step performed ahead of the correcting step, preferably ahead of the setting step. During this calibration step, wet films of the radcure paint to be used on the coil-coating line are exposed to different UV doses, cured by EB in standard curing conditions and the gloss of the organic coating is measured. Function f₁ can thus be deducted for each radcure paint. This calibration step can be done once and for all and does not have to be performed each time the method according to the invention is implemented.

Preferably, function f₁ of the predefined mathematical relation between the UV dose to which the wet film of radcure paint is exposed and the gloss of the organic coating after Electron-Beam curing is set during the setting step. By “predefined”, it is meant that a calibration step, preferably as described above, has been performed before implementing the method on the coil-coating line. The function f₁ can be manually entered in the gloss management tool, in particular in the setting module. Alternatively, it can be automatically obtained by crossing the predefined mathematical relations entered in the gloss management tool with the paint reference from the order book of the coil-coating line, in particular from the scheduling tool.

For example, it has been observed that for radcure paints commercially available for coil-coating of steel, f₁ is usually related to a gloss curve decreasing towards an asymptote as the UV dose increases.

Once the corrected UV dose has been calculated, the result of the calculation, i.e. corrected UV dose D_{c}, is preferably made available to a line operator. The latter can make the necessary corrections.

Generally speaking, a line setting other than the power of the cooling module, other than the power of the heating module if applicable and other than the power of the inductor if applicable, is adjusted taking into account the calculated corrected UV dose D_{c}, so that the gloss of value Gₛ is obtained on the organic coating in the at least a width portion of the moving strip downstream of the Electron-Beam curing device.

In the variant illustrated in FIG. 3, once the corrected UV dose has been calculated, the power of the UV module is adjusted, in particular lowered, so that the wet film in the at least a width portion of the moving strip is exposed to the UV dose D_{c} in the UV module. Thanks to the adjustment of the UV module, the UV dose to which the wet film is exposed in the width portion in the UV module is corrected and gloss of value Gₛ is obtained on the organic coating in the width portion downstream of the Electron-Beam curing device. The adjustment of the power of the UV module can be done either manually by an operator or automatically with the help of the gloss management tool.

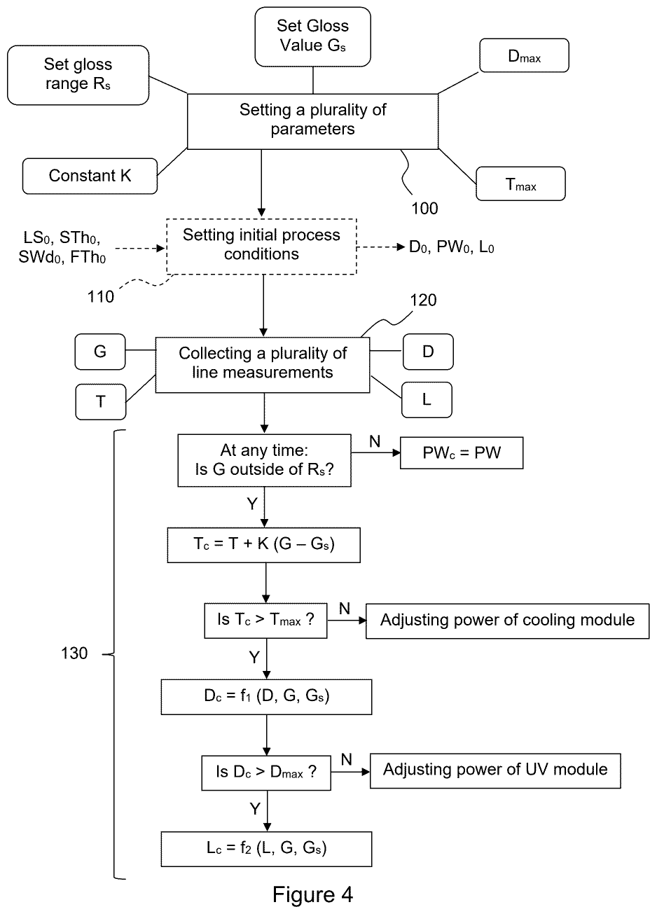

A third embodiment of the method is now described with reference to FIG. 4.

This embodiment mainly differs from the second one in that the correcting step comprises additional sub-steps to:
ensure that the calculated corrected UV dose D_{c} is not below a minimum UV dose Dₘᵢₙ to which the wet film can be exposed,
correct the deviation of the measured gloss G accordingly.

Thanks to this configuration, the method further prevents the undercuring of the wet film in the UV curing device, which might impact detrimentally the gloss.

The details provided when describing the first and second embodiments apply for the third embodiment. The additional steps and corresponding features are described in detail now.

In this embodiment, the UV module of the Ultra-Violet curing device of the coil-coating line is movable along the path P. Accordingly the length L between the UV module and the Electron-Beam curing device can be adjusted.

The setting step 100 further comprises setting a minimum UV dose Dₘᵢₙ to which the wet film can be exposed in the UV module. This UV dose can be the one recommended by the paint supplier. It can alternatively be identified by the operator of the coil-coating line notably during a calibration step. From a practical point of view, the minimum UV dose Dₘᵢₙ can be manually entered in the gloss management tool, in particular in the setting module. Alternatively, it can be automatically obtained by crossing the different minimum UV doses entered in the gloss management tool with the paint reference from the order book of the coil-coating line, in particular from the scheduling tool.

The collecting step 120 further comprises collecting the length L between the UV module and the Electron-Beam curing device. This length is generally known from the operator, possibly from the management tool of the coil-coating line. It can be collected manually. Preferably it is collected in the gloss management tool, more preferably automatically with the appropriate interface. Preferably, it is collected only when the length L is modified.

During the correcting step 130, once the corrected UV dose D_{c} has been calculated, it is compared to the minimum UV dose Dₘᵢₙ. If D_{c} is superior to Dₘᵢₙ, then the power/setting of the UV module is adjusted so that the wet film in the at least a width portion of the moving strip is exposed to the UV dose De in the UV module. Thanks to the adjustment of the UV module, the UV dose to which the wet film is exposed in the width portion in the UV module is corrected and a gloss of value Gₛ is obtained on the organic coating in the width portion downstream of the Electron-Beam curing device, as in the second embodiment.

If D_{c} is inferior to Dₘᵢₙ, then the gloss has to be corrected without decreasing the UV dose of the UV module any further. One way to do so is to adjust, in particular to shorten, the length between the UV module and the Electron-Beam curing device. It has indeed been observed that it impacts the gloss of the organic coating. The shorter the time between the UV curing and the EB curing, the higher the gloss. Consequently, the correcting step 130 further comprises calculating the corrected length L_{c} between the UV module and the Electron-Beam curing device according to equation 3:

$${L}_{c} = {f}_{2} ( L , G , {G}_{s} ) \qquad ( 3 )$$

Equation (3) can be obtained in a calibration step performed ahead of the correcting step, preferably ahead of the setting step. During this calibration step, wet films of the radcure paint to be used on the coil-coating line are exposed sequentially to UV curing and EB curing in standard curing conditions with varying time between the two curings and the gloss of the organic coating is measured. Function f₂ can thus be deducted for each radcure paint. This calibration step can be done once and for all and does not have to be performed each time the method according to the invention is implemented.

Preferably, function f₂ of the predefined mathematical relation between the length between the UV module and the Electron-Beam curing device and the gloss of the organic coating after Electron-Beam curing is set during the setting step. By “predefined”, it is meant that a calibration step, preferably as described above, has been performed before implementing the method on the coil-coating line. The function f₂ can be manually entered in the gloss management tool, in particular in the setting module. Alternatively, it can be automatically obtained by crossing the predefined mathematical relations entered in the gloss management tool with the paint reference from the order book of the coil-coating line, in particular from the scheduling tool.

For example, it has been observed that for radcure paints commercially available for coil-coating of steel, f₂ is usually related to a gloss curve decreasing towards an asymptote as L increases.

Once the corrected length has been calculated, the result of the calculation, i.e. corrected length L_{c}, is preferably made available to a line operator. The latter can make the necessary corrections.

Generally speaking, a line setting other than the power of the cooling module, other than the power of the heating module if applicable, other than the power of the inductor if applicable, and other than the power of the UV module is adjusted taking into account the calculated corrected length L_{c}, so that the gloss of value Gₛ is obtained on the organic coating in the at least a width portion of the moving strip downstream of the Electron-Beam curing device.

In the variant illustrated in FIG. 4, once the corrected length has been calculated, the length between the UV module and the Electron-Beam curing device is adjusted, in particular shortened, to the corrected length Le so that the gloss of value Gₛ is obtained on the organic coating in the at least a width portion of the moving strip downstream of the Electron-Beam curing device. The adjustment of the length can be done either manually by an operator or automatically with the help of the gloss management tool.

Alternatively, notably if the length between the UV module and the Electron-Beam curing device cannot be further extended or shortened, the line speed can be adjusted. In that case, the initial line setting can be performed again to adjust, to the new line speed, the initial power PW₀ of the cooling module, the initial UV dose Do of the Ultra-Violet curing device and the initial length L₀ between the Ultra-Violet curing device and the Electron-Beam curing device.

The invention also relates to a method for forming an organic coating on a moving strip on a coil-coating line comprising, sequentially along the path P of the moving strip, a paint applicator, a cooling device comprising a cooling module, an Ultra-Violet curing device and an Electron-Beam curing device, the method comprising the steps of:
applying a wet film of a radcure paint on the moving strip with the paint applicator,
exposing the wet film of radcure paint to UV in the Ultra-Violet curing device,
curing the wet film of radcure paint in the Electron-Beam device to form the organic coating,
the gloss of the organic coating being managed by:
Setting a set gloss value Gₛ of the organic coating, a set gloss range Rₛ of the gloss of the organic coating and a proportionality constant K of a predefined linear mathematical relation between the temperature of the wet film before Ultra-Violet curing and the gloss of the organic coating after Electron-Beam curing,
Collecting the measure of the temperature T of the wet film in at least a width portion of the moving strip downstream of the cooling module and upstream of the Ultra-Violet curing device and collecting the measure of the gloss G of the organic coating in the at least a width portion downstream of the Electron-Beam curing device,
Correcting a deviation of the measured gloss G beyond the set gloss range Rₛ, this correcting step comprising a sub-step of calculating the corrected temperature T_{c} to be reached by the wet film, in the at least a width portion downstream of the cooling module and upstream of the Ultra-Violet curing device, according to equation 1:

$${T}_{c} = T + K ( G - {G}_{s} ) \qquad ( 1 )$$

and a sub-step of adjusting a setting of the coil-coating line taking into account the calculated corrected temperature T_{c}.

All the details provided in relation to the method for managing the gloss and all the details provided in relation to the coil-coating line apply to the method for forming the organic coating.

The invention also relates to a method for manufacturing a prepainted metal, comprising a metal strip and an organic coating, on a coil-coating line comprising, sequentially along the path P of the moving metal strip, a paint applicator, a cooling device comprising a cooling module, an Ultra-Violet curing device and an Electron-Beam curing device, the method comprising the steps of:
applying a wet film of a radcure paint on the moving metal strip with the paint applicator,
cooling the wet film of radcure paint in the cooling module,
exposing the wet film of radcure paint to UV in the Ultra-Violet curing device,
curing the wet film of radcure paint in the Electron-Beam device to form the organic coating,
the gloss of the organic coating being managed by:
Setting a set gloss value Gₛ of the organic coating, a set gloss range Rₛ of the gloss of the organic coating and a proportionality constant K of a predefined linear mathematical relation between the temperature of the wet film before Ultra-Violet curing and the gloss of the organic coating after Electron-Beam curing,
Collecting the measure of the temperature T of the wet film in at least a width portion of the moving strip downstream of the cooling module and upstream of the Ultra-Violet curing device and collecting the measure of the gloss G of the organic coating in the at least a width portion downstream of the Electron-Beam curing device,
Correcting a deviation of the measured gloss G beyond the set gloss range Rₛ, this correcting step comprising a sub-step of calculating the corrected temperature T_{c} to be reached by the wet film, in the at least a width portion downstream of the cooling module and upstream of the Ultra-Violet curing device, according to equation 1:

$${T}_{c} = T + K ( G - {G}_{s} ) \qquad ( 1 )$$

and a sub-step of adjusting a setting of the coil-coating line taking into account the calculated corrected temperature T_{c}.

Optionally, the metal strip can be heated before applying the wet film of radcure paint.

All the details provided in relation to the method for managing the gloss and all the details provided in relation to the coil-coating line apply to the method for manufacturing the prepainted metal.

What is claimed is:

1-10. (canceled)

11. A method for managing the gloss of an organic coating formed by application and curing of a wet film of a radcure paint on a moving strip on a coil-coating line having, sequentially along the path P of the moving strip, a paint applicator, a cooling device including a cooling module, an Ultra-Violet curing device and an Electron-Beam curing device, the method comprising the steps of:
setting a set gloss value Gₛ of the organic coating, a set gloss range Rₛ of the gloss of the organic coating and a proportionality constant K of a predefined linear mathematical relation between the temperature of the wet film before Ultra-Violet curing and the gloss of the organic coating after Electron-Beam curing;
collecting a measure of the temperature T of the wet film in at least a width portion of the moving strip downstream of the cooling module and upstream of the Ultra-Violet curing device and collecting a measure of the gloss G of the organic coating in the at least a width portion downstream of the Electron-Beam curing device; and
correcting a deviation of the measured gloss G beyond the set gloss range Rₛ, this correcting step comprising a sub-step of calculating the corrected temperature T_{c} to be reached by the wet film, in the at least a width portion downstream of the cooling module and upstream of the Ultra-Violet curing device, according to equation 1:
$${T}_{C} = T + K ( G - {G}_{s} ) \qquad ( 1 )$$
and a sub-step of adjusting a setting of the coil-coating line taking into account the calculated corrected temperature T_{c}.

12. The method as recited in claim 11 wherein the cooling device is chosen from the group consisting of: a forced-air cooler, a water spray cooler, a water-air fog spray cooler and a cooled roll.

13. The method as recited in claim 11 wherein the coil-coating line further comprises a heating device positioned between the paint applicator and the Ultra-Violet curing device.

14. The method as recited in claim 11 wherein the sub-step of adjusting a setting of the coil-coating line comprises adjusting the power of the cooling module so that the wet film reaches the corrected temperature T_{c} in the at least a width portion of the moving strip downstream of the cooling module and upstream of the Ultra-Violet curing device.

15. The method as recited in claim 11 wherein:
the Ultra-Violet curing device comprises a UV module,
the setting step further comprises setting a minimum temperature Tₘᵢₙ for the radcure paint,
the collecting step further comprises collecting the UV dose D of the UV module,
the sub-step of adjusting a setting of the coil-coating line comprises:
evaluating if T_{c} is inferior to Tₘᵢₙ,
when not, adjusting the power of the cooling module so that the wet film reaches the corrected temperature T_{c} in the at least a width portion of the moving strip downstream of the cooling module and upstream of the Ultra-Violet curing device,
when T_{c} is inferior to Tₘᵢₙ:
calculating the corrected UV dose D_{c} to which the wet film in the at least a width portion must be exposed in the UV module according to equation 2:
$${D}_{c} = {f}_{1} ( D , G , {G}_{s} ) \qquad ( 2 )$$
adjusting a setting of the coil-coating line other than the power of the cooling module, taking into account the calculated corrected UV dose D_{c}.

16. The method as recited in claim 15 wherein the sub-step of adjusting a setting of the coil-coating line other than the power of the cooling module comprises adjusting the power of the UV module so that the wet film in the at least a width portion of the moving strip is exposed to the corrected UV dose D_{c}.

17. The method as recited in claim 15 wherein:
the UV module is movable along the path P,
the setting step further comprises setting a minimum UV dose Dₘᵢₙ to which the wet film can be exposed in the UV module,
the collecting step further comprises collecting the length L between the UV module and the Electron-Beam curing device,
the sub-step of adjusting a setting of the coil-coating line other than the power of the cooling module comprises:
evaluating if De is inferior to Dₘᵢₙ,
when not, adjusting the power of the UV module so that the wet film in the at least a width portion of the moving strip is exposed with the corrected UV dose D_{c},
when D_{c} is inferior to Dₘᵢₙ:
calculating the corrected length L_{c} between the UV module and the Electron-Beam curing device according to equation 3:
$${L}_{c} = {f}_{2} ( L , G , {G}_{s} ) \qquad ( 3 )$$
adjusting a setting of the coil-coating line other than the power of the cooling module and other than the power of the UV module, taking into account the calculated corrected length L_{c}.

18. The method as recited in claim 17 wherein the sub-step of adjusting a setting of the coil-coating line other than the power of the cooling module and other than the power of the UV module comprises adjusting the length between the UV module and the Electron-Beam curing device to the corrected length L_{c} so that the gloss of value Gₛ is obtained on the organic coating in the at least a width portion of the moving strip downstream of the Electron-Beam curing device.

19. A coil-coating line comprising:
sequentially a paint applicator, a cooling device comprising a cooling module, an Ultra-Violet curing device and an Electron-Beam curing device; and
further comprising a gloss management tool for managing the gloss of an organic coating formed by application and curing of a wet film of a radcure paint on a moving strip on the coil-coating line, the gloss management tool comprising:
a setting module setting a set gloss value Gₛ of the organic coating, a set gloss range Rₛ of the gloss of the organic coating and a proportionality constant K of a predefined linear mathematical relation between the temperature of the wet film before Ultra-Violet curing and the gloss of the organic coating after Electron-Beam curing,
an acquisition module collecting the measure of the temperature T of the wet film in at least a width portion of the moving strip downstream of the cooling module and upstream of the Ultra-Violet curing device and collecting a measure of the gloss G of the organic coating in the at least a width portion downstream of the Electron-Beam curing device,
a correction module correcting a deviation of the measured gloss G beyond the set gloss range Rₛ, the correction comprising calculating the corrected temperature T_{c} to be reached by the wet film, in the at least a width portion downstream of the cooling module and upstream of the Ultra-Violet curing device, according to equation 1:
$${T}_{c} = T + K ( G - {G}_{s} ) \qquad ( 1 )$$
and adjusting a setting of the coil-coating line taking into account the calculated corrected temperature T_{c}.

20. The coil-coating line as recited in claim 19 wherein the cooling device is chosen from the group consisting of: a forced-air cooler, a water spray cooler, a water-air fog spray cooler and a cooled roll.
